(19) United States
(12) Patent Application Publication
(10) Pub. No.: US 2015/0350600 A1
(43) Pub. Date: Dec. 3, 2015

(54) VISUAL CALL APPARATUS AND METHOD

(71) Applicant: HEWLETT-PACKARD DEVELOPMENT COMPANY, L.P., Houston, TX (US)

(72) Inventors: Ingo BEINLICH, Palo Alto, CA (US); Henri J. SUERMONDT, Palo Alto, CA (US); Christopher WILLIS, Palo Alto, CA (US); Jerome ROLIA, Palo Alto, CA (US)

(21) Appl. No.: 14/439,763

(22) PCT Filed: Oct. 31, 2012
(86) PCT No.: PCT/US2012/062871

§ 371 Date: Apr. 30, 2015

(51) Int. Cl. H04N 7/15; G06F 19/00

(52) U.S. Cl. CPC H04N 7/15; G06F 19/3418; G06F 19/3406; G06F 19/3487

(57) ABSTRACT

According to an example, a visual call apparatus is described for providing a health care service to a user. The apparatus includes a memory storing machine readable instructions to receive input related to a health related status of a user. The machine readable instructions analyze the health related status of the user to select options, from a plurality of available options, to provide services to the user. The user is to actuate one of the selected options to receive a service related to the actuated option. The machine readable instructions further output the selected options to allow the user to actuate one of the selected options, and upon actuation of one of the selected options, provide feedback to the user related to completion of the service related to the actuated option. The apparatus includes a processor to implement the machine readable instructions.

### BACKGROUND

Service facilities, such as health care facilities, typically provide users with a call button or device to alert a service provider if a service is needed. In response to the request from a user, a service provider may call the user to determine the user's needs, or otherwise, go to where the user is located to determine what the user needs. Often, the user may have to wait an unreasonable amount of time before the service is provided. The service provider may likewise be unable to provide services to a user if they are similarly providing services to other users, or if the services are unavailable. These aspects can negatively impact the quality of services provided.

### BRIEF DESCRIPTION OF DRAWINGS

Features of the present disclosure are illustrated by way of example and not limited in the following figure(s), in which like numerals indicate like elements, in which:

FIG. 1 illustrates an architecture of a visual call apparatus, according to an example of the present disclosure;

FIG. 2 illustrates an example of a layout of the visual call apparatus in a health care environment, according to an example of the present disclosure;

FIG. 3 illustrates an example of a user interface display for a service request using the visual call apparatus, according to an example of the present disclosure;

FIG. 4 illustrates an example of feedback for the user interface display for a service request, according to an example of the present disclosure;

FIG. 5 illustrates an example of a multi-lingual display for the user interface display for the visual call apparatus, according to an example of the present disclosure;

FIG. 6 illustrates another example of a user interface display for a service request for a bathroom option using the visual call apparatus, according to an example of the present disclosure;

FIG. 7 illustrates an example of a user interface display for a problem report using the visual call apparatus, according to an example of the present disclosure;

FIG. 8 illustrates an example of a user interface display for a rating and scaling request using the visual call apparatus, according to an example of the present disclosure;

FIG. 9 illustrates an example of a user interface display for a communication request using the visual call apparatus, according to an example of the present disclosure;

FIG. 10 illustrates an example of a user interface display for a questions request using the visual call apparatus, according to an example of the present disclosure;

FIG. 11 illustrates an example of a user interface display for an emergency request using the visual call apparatus, according to an example of the present disclosure;

FIG. 12 illustrates an example of a service provider interface display using the visual call apparatus, according to an example of the present disclosure;

FIG. 13 illustrates a graph for evaluation of medical events per patient and service events per patient using the visual call apparatus, according to an example of the present disclosure;

FIG. 14 illustrates a graph for evaluation of response time using the visual call apparatus, according to an example of the present disclosure;

FIG. 15 illustrates a report generated using the visual call apparatus, according to an example of the present disclosure;

FIG. 16 illustrates a method for visual calling, according to an example of the present disclosure;

FIG. 17 illustrates further details of the method for visual calling, according to an example of the present disclosure; and

FIG. 18 illustrates a computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

In service facilities, such as health care facilities, users (e.g., patients) have needs that drive a supply chain of services. For example, users may need a variety of services, such as medication, bedding, pain management, any type of assistance, etc. In order to request a service, a user may use a device, such as a call button, to contact a service provider, such as a nurse. The service provider may call the user to determine the user's needs, or otherwise, go to where the user is located to determine what the user needs. This approach to providing service to a user can be inefficient in the time it takes for a user to convey his/her intent to the service provider, and the time it takes for the service provider to determine the user's intent and provide the necessary service. The service provider may also expend needless time and effort in providing services that may be provided by other ordinary staff, and thus limit the scope of certain services to specialized staff.

A visual call apparatus and a method for visual calling are described, and provide users, such as patients in a health care facility, with the ability to precisely communicate their needs and to document aspects of the services they receive. The visual call apparatus and method for visual calling improve user experience, for example, by engaging the user directly with the supply chain of services. Costs associated with services are reduced, for example, by removing unnecessary work from the service facility and by providing for efficient use of service staff. Outcome and quality of services provided are improved, for example, by documenting the services received by users to thus allow users and service providers to review all aspects of services provided. The visual call apparatus and method for visual calling also provide a quantitative measure to a user experience that can be used for benchmarking, for example, across a service provider's organization.

The visual call apparatus and method for visual calling provide for definition of the need for a service at a first point of contact, for example, at the patient in a health care environment, so that a service provider does not waste time determining what service is needed. For a service facility, knowing the nature of a needed service facilitates assignment of a service task to a service provider with the appropriate skills. For example, in a health care environment, a nurse is not needed to provide a blanket. In such a case, an orderly or another staff member may be able to satisfy such requests so that nurses can spend their time performing tasks more related to their advanced skill set.

The visual call apparatus and method for visual calling also provide improved resource utilization. For example, information related to service requests may be tracked and analyzed. This analysis may be used to generate reports on the rate of service requests and service metrics, such as waiting times, service demands, etc. A number of staff members for a service type may also be predicted based on analysis of information related to service requests. The number of predicted staff members may be used to support one or more users to obtain specific service levels based, for example, on knowledge of a user's records (e.g., health records), purpose of stay in a health care facility, expected remaining stay, etc.

Generally, the visual call apparatus and method for visual calling include a user interface that is provided to users and includes a configurable vocabulary. The vocabulary may be restricted based on the services needed by a specific user. The restricted vocabulary may be used for analysis of user interactions with the visual call apparatus. However, a user may be provided further assistance from a service provider if the user requests services that are outside the scope of the options and sub-options provided by the visual call apparatus. The user interface may also receive and display responses in the restricted vocabulary. The user interface may present information to a user in one or more languages so that the user may request a service in the user's preferred language. Thus, the user interface may display translated communications to/from the user interface between a working language of the service provider's facility and the language preferred by the user. The user interface may display service options according to context such that users are first presented with services they are most likely to need. The service options displayed may be adaptive such that the services a user actually needs are considered as part of the context. Call volumes and staff availability may affect services that are available or may be imparted to the user. Thus, the user interface may display a reduced number of services that are available based on staff availability. The user interface may also include touch, verbal, and/or tapping interfaces to provide accessible navigation, for example, to patients in beds in a health care facility.

When a user receives a service, the visual call apparatus and method for visual calling may record, and in a secure manner, store information related to the service provided. For example, in a health care environment, a doctor may visit a patient to evaluate and report on the progress of the patient's health. Such interactions may be recorded. The recordation of such interactions may provide a user with an interface for recording and replaying reports for further analysis. A user may also invoke a secure and appropriate translation or analysis service, with a human or other operator, to translate and further explain such verbal reports. A user's records of interactions may be stored for further or future analysis by additional service providers. The recordation and analysis of information provides for improvement in the service provided and received by users based, for example, on comparison of such services for other facilities, service providers and users. Furthermore, the recordation and analysis of information may also be used for staffing, and for benchmarking across an organization. For a health care environment, the patient oriented aspects of the visual call apparatus and method for visual calling provide improvements in patient care by allowing patients to engage in their own care, and make better use of available services.

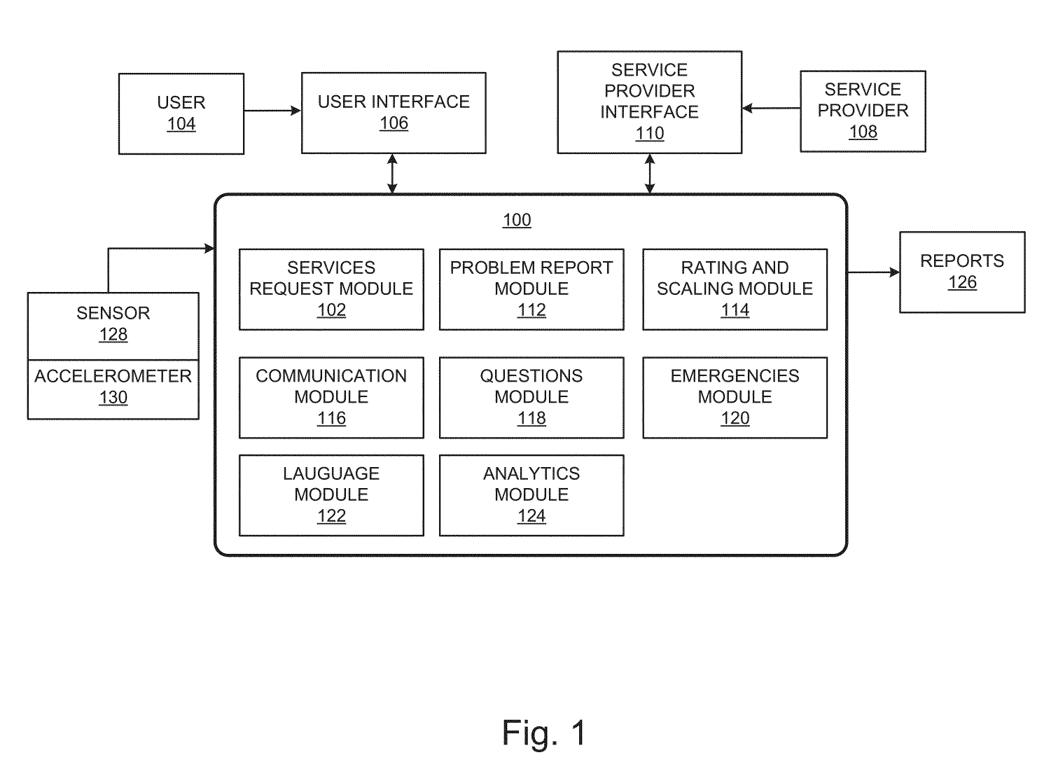

FIG. 1 illustrates an architecture of a visual call apparatus 100, according to an example. Referring to FIG. 1, the apparatus 100 is depicted as including a services request module 102 to provide a user 104 of the apparatus 100 with the ability to request services and receive service request feedback by using a user interface 106. The user interface 106 is to display the services available to the user 104 in a restricted vocabulary provided by a facility that uses a service provider 108 to provide services to the user 104. The service provider 108 may interact with a service provider interface 110 to receive and manage services that are provided to the user 104. A problem report module 112 is to report problems to the service provider 108 and receive feedback for the reported problems, for example, as to estimated completion time of the reported problems. A rating and scaling module 114 is provided with the apparatus 100 when used, for example, in a health care environment, to report a level of pain the user 104 may be experiencing. A communication module 116 is to communicate a predetermined set of messages to the service provider 108. A questions module 118 is to request answers to a predetermined set of questions from the service provider 108. An emergencies module 120 is provided with the apparatus 100 when used, for example, in a health care environment, to alert the service provider 108 to emergencies, which may be categorized. A language module 122 is to facilitate communication, for example, between the user 104 and the service provider 108, in predetermined languages preferred by the user 104 and the service provider 108. An analytics module 124 is to monitor and analyze data related to any interaction using the apparatus 100, for example, to control operations of the apparatus 100, to provide appropriate displays and responses on the user interface 106 and the service provider interface 110, and to generate reports 126 based on the analysis. A sensor 128 is to sense, for example, vibrations in the vicinity of the user 104 and communicate with the analytics module 124. Signals received from the sensor 128 may be used to determine, for example, a condition of the user 104.

The modules 102, 112, 114, 116, 118, 120, 122, and 124, and other components of the apparatus 100 that perform various other functions in the apparatus 100, may comprise machine readable instructions stored on a computer readable medium. In addition, or alternatively, the modules 102, 112, 114, 116, 118, 120, 122, and 124, and other components of the apparatus 100 may comprise hardware or a combination of machine readable instructions and hardware.

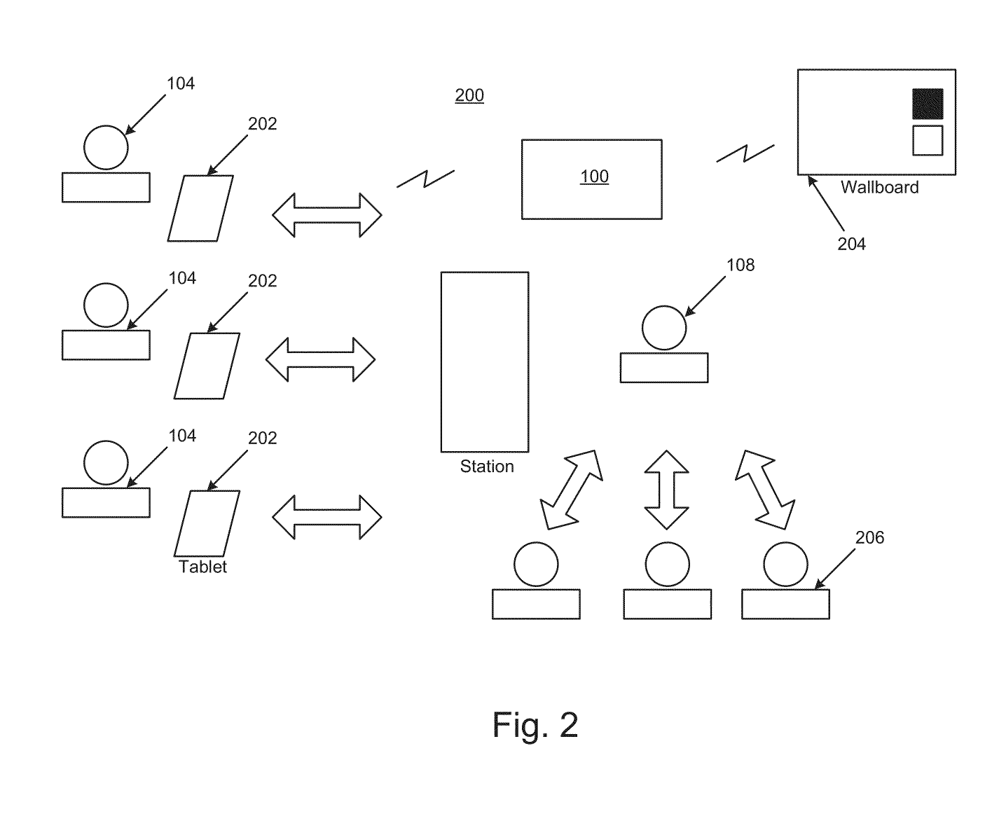

FIG. 2 illustrates an example of a layout of the visual call apparatus 100 in a health care environment 200, according to an example of the present disclosure. Referring to FIGS. 1 and 2, the health care environment 200 may generally include a plurality of the users 104 that wirelessly interface with the visual call apparatus 100, for example, via tablets 202 that include displays associated with the user interface 106 provided thereon. Instead of or in addition to the tablets 202, other dedicated devices (e.g., a tray table, an arm integrated with a bed, other mobile devices) may be used. The service provider 108 may receive and process service requests received from the users 104, for example, at wallboard 204 that includes a display associated with the service provider interface 110 provided thereon. The service provider 108 may manage the service requests, for example, by fulfilling the service requests, or by assigning appropriate service providers 206 to fulfill the requests. Service requests may also be routed directly to other service providers, such as orderlies or other staff without intervention by nursing staff. In this way, the workload for nursing staff or other essential staff may be reduced.

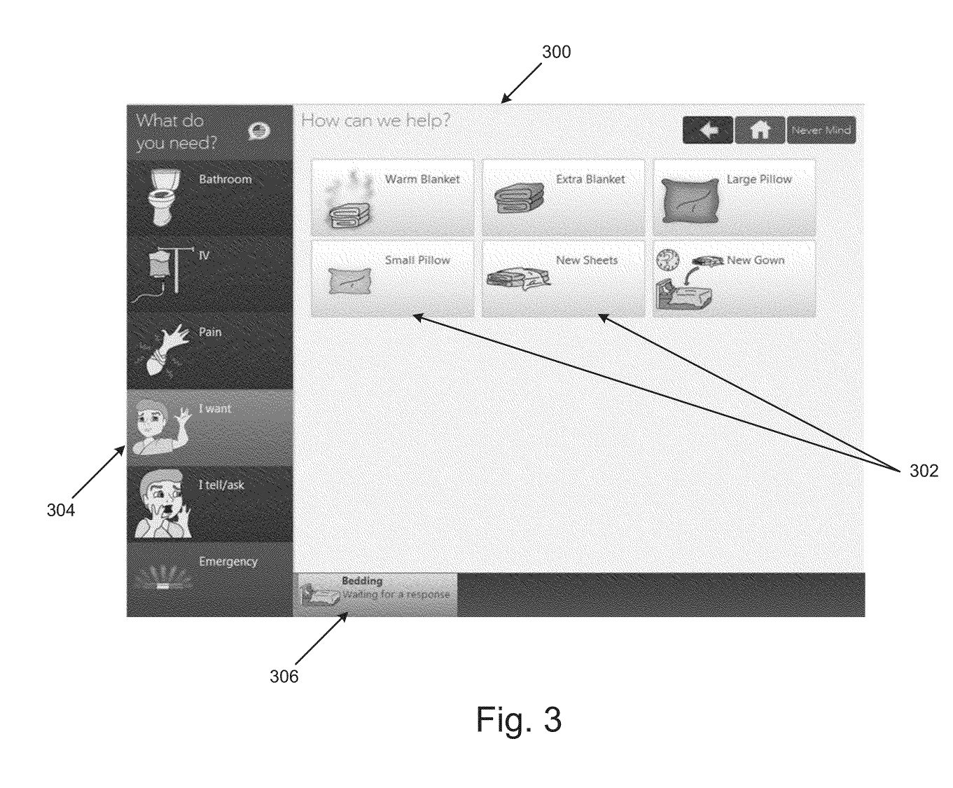

FIG. 3 illustrates an example of a user interface display 300 for a service request using the visual call apparatus 100, according to an example of the present disclosure. Referring to FIGS. 1 and 3, in order for the user 104 to request a service from the service provider 108, the services request module 102 displays a plurality of service sub-options 302 for an associated service option 304. For a health care environment, the service sub-options 302 may include, for example, a request for a warm blanket, an extra blanket, a large pillow, etc. Using such service options and sub-options facilitate communication with the user 104, for example, by providing a language independent display to the user 104 to request one or more services. When the user 104 selects the service option 304, for example, by touching the screen of the tablet 202 (see FIG. 2), the service sub-options 302 that are specific to the user 104 and the available services options that can be provided by the service provider 108 may be displayed at the user interface display 300. The service sub-options 302 that are specific to the user 104 and the available services options that can be provided by the service provider 108 may be determined by the analytics module 124 based on monitoring and analysis of data related to interactions with the apparatus 100. The user interface display 300 may also include a status window 306 related to the service sub-options 302 or the service option 304 that is selected. The service sub-options 302 and service option 304 may be a one-touch macro that triggers the desired service, and automatically controls the functions of the user's environment at a single touch. For example, for a health care environment, if the user selects a sleep service option (not shown), such an option may be used by the visual call apparatus 100 to dim lights in the user's room. The service option 304 (and other options) and sub-options 302 that are available to the user 104 may also be displayed based on factors specific to the user 104. For example, for a health care environment, if a user is in an intensive care unit (ICU) as opposed to outpatient recovery, service options and sub-options specific to the ICU or outpatient recovery may be presented on the user interface display 300. The user 104 may also use the services request module 102 to define a service option and/or sub-option that is unavailable, but is made available upon approval by the service provider. The user interface 106 and the service provider interface 110 may also display other options and/or sub-options based, for example, on specific aspects related to the type of services provided (e.g., diet services). The order of the options and sub-options may be based, for example, on frequency of use.

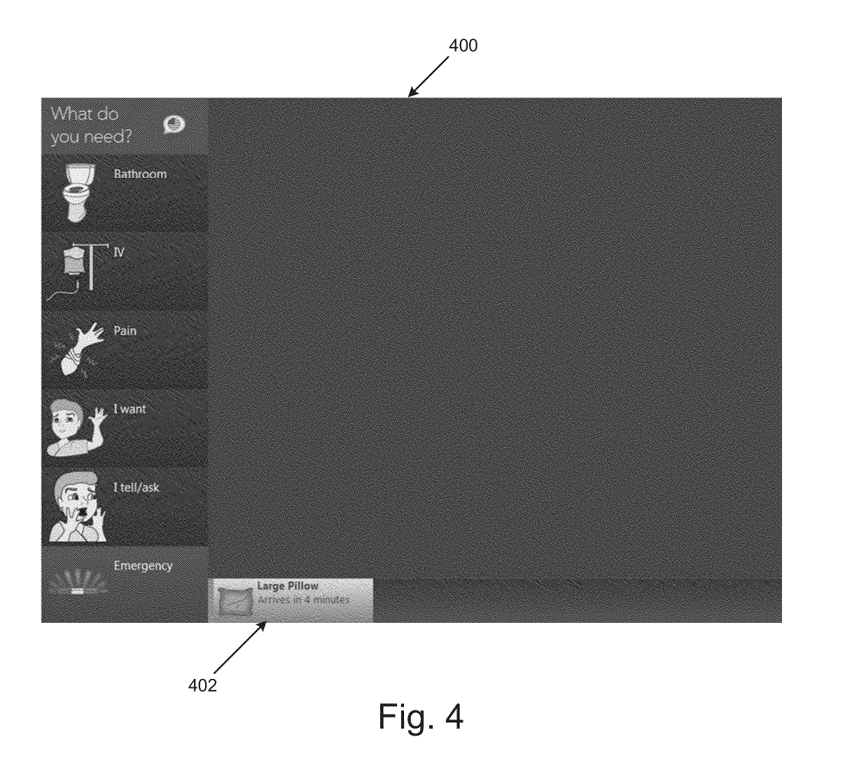

FIG. 4 illustrates an example of feedback for a user interface display 400 for a service request, according to an example of the present disclosure. Referring to FIGS. 3 and 4, for a service sub-option 302 selected by the user 104, for example, for requesting a large pillow, the user interface display 400 may provide feedback to the user 104 in the status window 402. Additional feedback may be provided to the user 104 in a similar manner for other options that are selected. Feedback may include, for example, availability of a service, expected time of service completion, alternative services, which service provider is expected to complete the requested service, etc. The feedback and communication in general with the user 104 and the service provider 108 by the user interface 106 and the service provider interface 110 may be provided visually, audibly, or using other modes of communication.

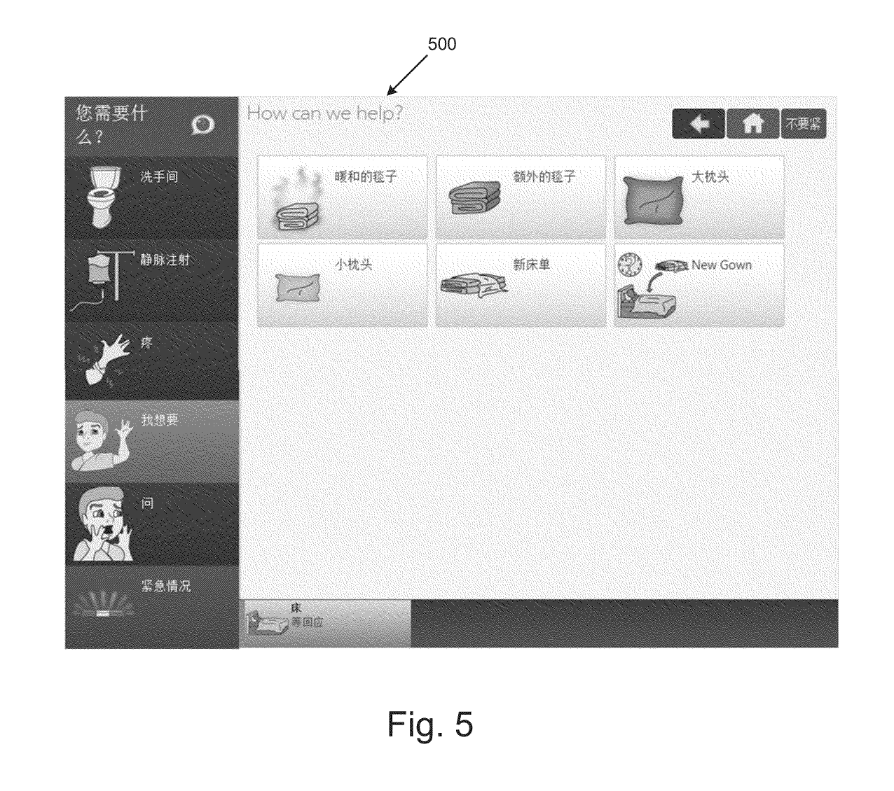

FIG. 5 illustrates an example of a multi-lingual display 500 for the user interface display for the visual call apparatus 100, according to an example of the present disclosure. Referring to FIGS. 1 and 5, using the language module 122, the multi-lingual display 500 may present a variety of options and sub-options (e.g., service option 304, service sub-options 302) to the user 104 in a language selected by the user 104. The language module 122 and the analytics module 124 may ascertain languages preferred by the user 104 and the service provider 108, and provide appropriate displays at the user interface 106 and the service provider interface 110. For example, for a health care environment, the language module 122 and the analytics module 124 may customize vocabulary according the characteristics of a hospital unit (e.g., intensive care unit (ICU), children's ward, rehab unit), the patient demographics (e.g., gender, age), the patient diagnosis, and the therapeutic regimen (e.g., intravenous line, urine catheter) and risk factors (e.g., fall risk). The vocabulary may also be customized based, for example, on configuration setting (e.g., hospital unit), and information retrieved from external systems (e.g., electronic medical records, nurse management systems).

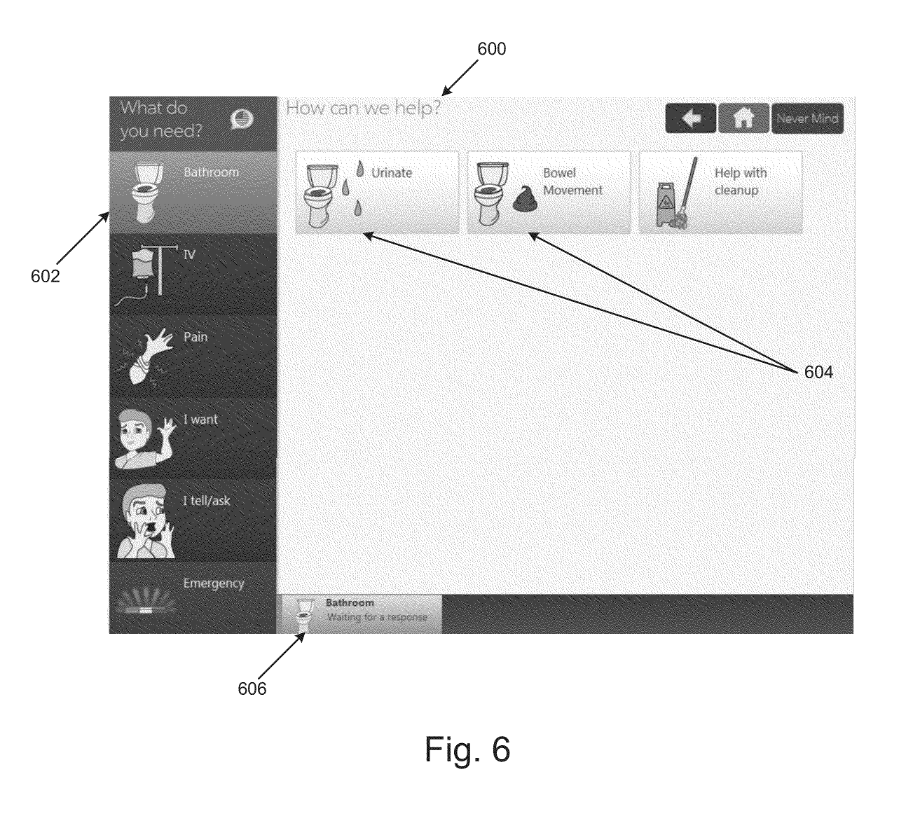

FIG. 6 illustrates another example of a user interface display 600 for a service request for a bathroom option 602 using the visual call apparatus 100, according to an example of the present disclosure. Referring to FIGS. 1 and 6, the bathroom option 602 may be specific to a health care environment, and include bathroom sub-options 604. The bathroom sub-options 604 that are specific to the user 104 and the available bathroom option 602 that can be provided by the service provider 108 may be determined by the analytics module 124 based, for example, on monitoring and analysis of data related to interactions with the apparatus 100. The user interface display 600 may also include a status window 606 related to the bathroom option 602, or the bathroom sub-option 604 that is selected.

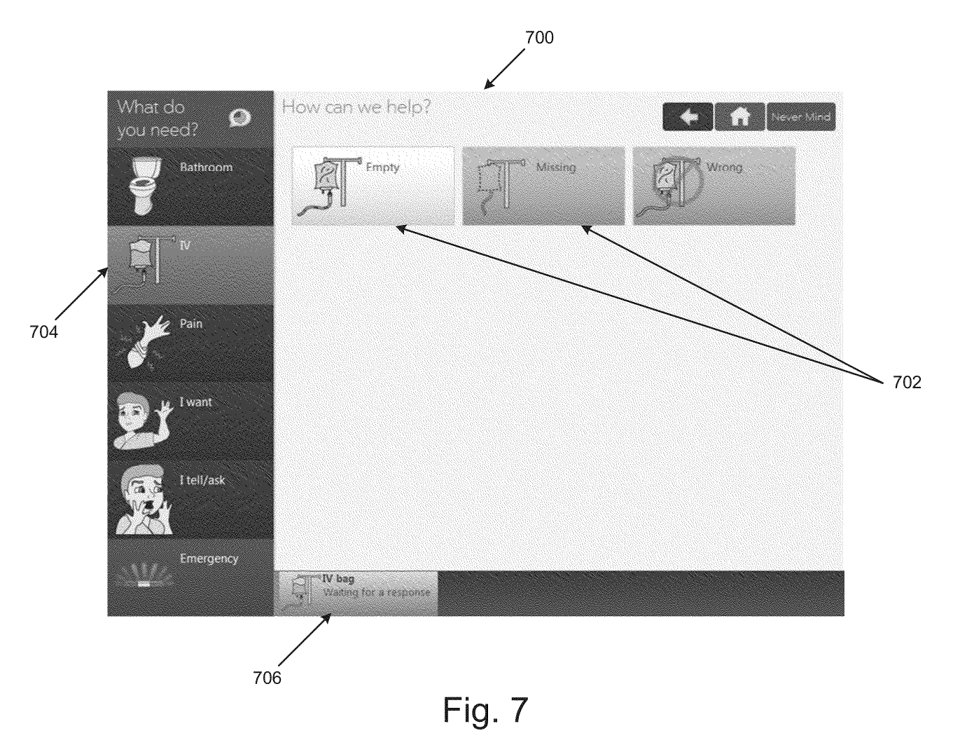

FIG. 7 illustrates an example of a user interface display 700 for a problem report using the visual call apparatus 100, according to an example of the present disclosure. Referring to FIGS. 1 and 7, using the problem report module 112, the user interface display 700 may present a variety of options and sub-options to the user 104. For example, for a health care environment, problem report sub-options 702 that are specific to the user 104 and the available problem report option 704 that can be provided by the service provider 108 may be determined by the analytics module 124 based on monitoring and analysis of data related to interactions with the apparatus 100. For the example shown in FIG. 7, the problem report option 704 may be related to intravenous (IV) therapy, and the problem report sub-options 702 may be related to an IV being empty, missing or incorrect. The user interface display 700 may also include a status window 706 related to the problem report option 704, or the problem report sub-option 702 that is selected.

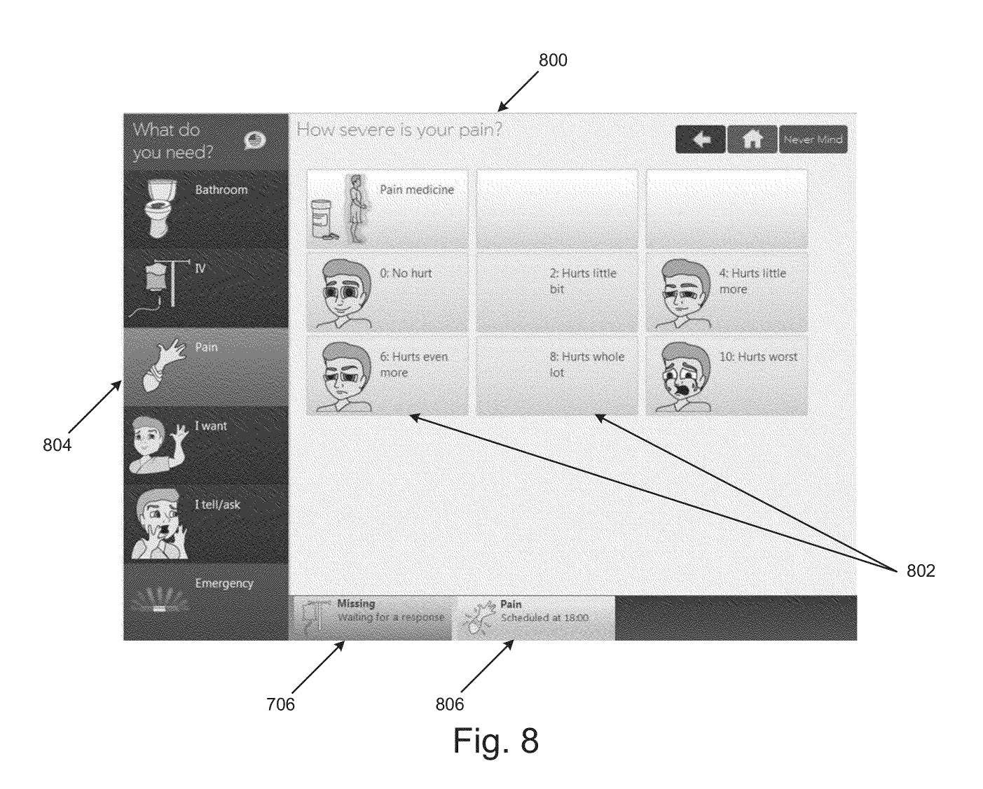

FIG. 8 illustrates an example of a user interface display 800 for a rating and scaling request using the visual call apparatus 100, according to an example of the present disclosure. Referring to FIGS. 1 and 8, using the rating and scaling module 114, the user interface display 800 may present a variety of options and sub-options to the user 104. For example, for a health care environment, rating and scaling sub-options 802 that are specific to the user 104 and the available rating and scaling option 804 that can be provided by the service provider 108 may be determined by the analytics module 124 based on monitoring and analysis of data related to interactions with the apparatus 100. The user interface display 800 may also include a status window 806 related to the rating and scaling option 804, or the rating and scaling sub-option 802 that is selected. For the example shown in FIG. 8, the rating and scaling option 804 may be related to pain, and the rating and scaling sub-options 802 may be related to levels of pain and pain medication. The user interface display 800 or any of the other user interface displays described herein may display any options or sub-options that are not completed prior to display of subsequently selected options or sub-options as shown. For example, for a problem report sub-option 702 that is not completed, the status window of FIG. 7 at 706 may remain active until the task is completed.

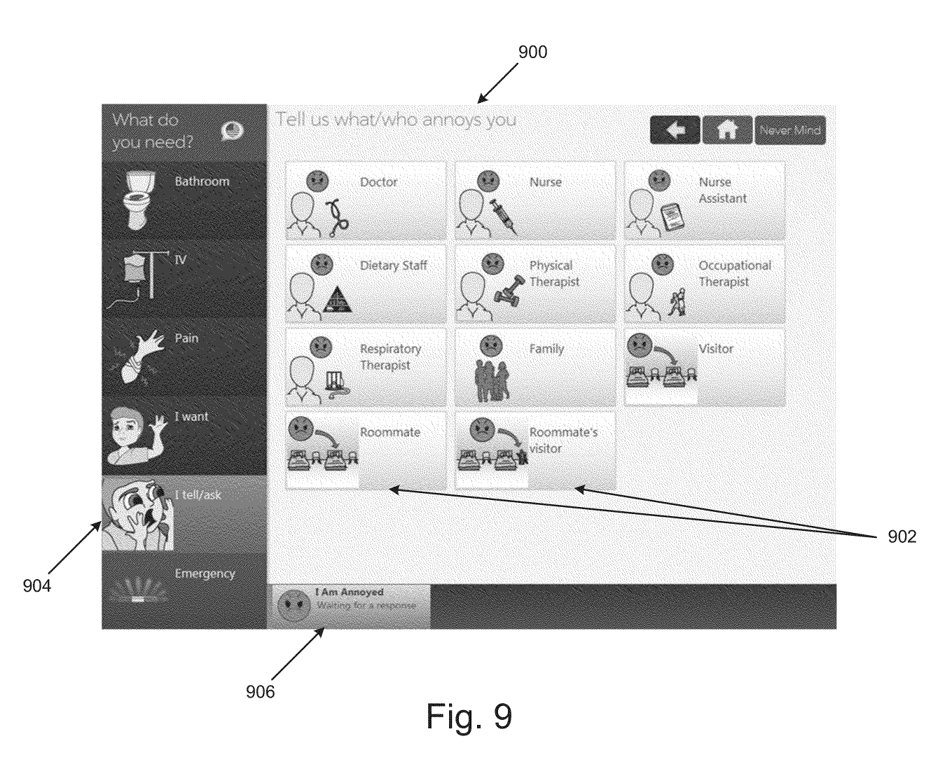

FIG. 9 illustrates an example of a user interface display 900 for a communication request using the visual call apparatus 100, according to an example of the present disclosure. Referring to FIGS. 1 and 9, using the communication module 116, the user interface display 900 may present a variety of options and sub-options to the user 104. For example, for a health care environment, communication sub-options 902 that are specific to the user 104 and the available communication option 904 that can be provided by the service provider 108 may be determined by the analytics module 124 based on monitoring and analysis of data related to interactions with the apparatus 100. For the example shown in FIG. 9, the communication option 904 may be related to someone a user wants to tell or ask about, and the communication sub-options 902 may be related to doctors, nurses, family, etc. The user interface display 900 may also include a status window 906 related to the communication option 904, or the communication sub-option 902 that is selected.

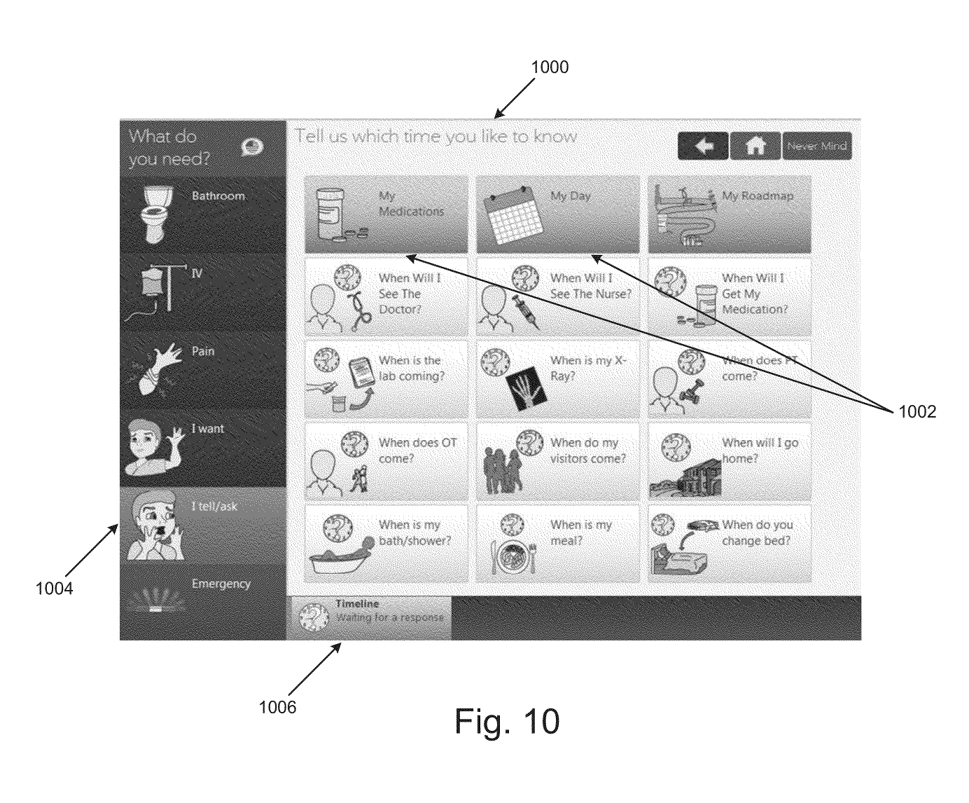

FIG. 10 illustrates an example of a user interface display 1000 for a questions request using the visual call apparatus 100, according to an example of the present disclosure. Referring to FIGS. 1 and 10, using the questions module 118, the user interface display 1000 may present a variety of options and sub-options to the user 104. For example, for a health care environment, questions sub-options 1002 that are specific to the user 104 and the available questions option 1004 that can be provided by the service provider 108 may be determined by the analytics module 124 based on monitoring and analysis of data related to interactions with the apparatus 100. For the example shown in FIG. 10, the questions option 1004 may be related to something a user wants to tell or ask about, and the questions sub-options 1002 may be related to medication, meal timings, etc. The user interface display 1000 may also include a status window 1006 related to the questions option 1004, or the questions sub-option 1002 that is selected.

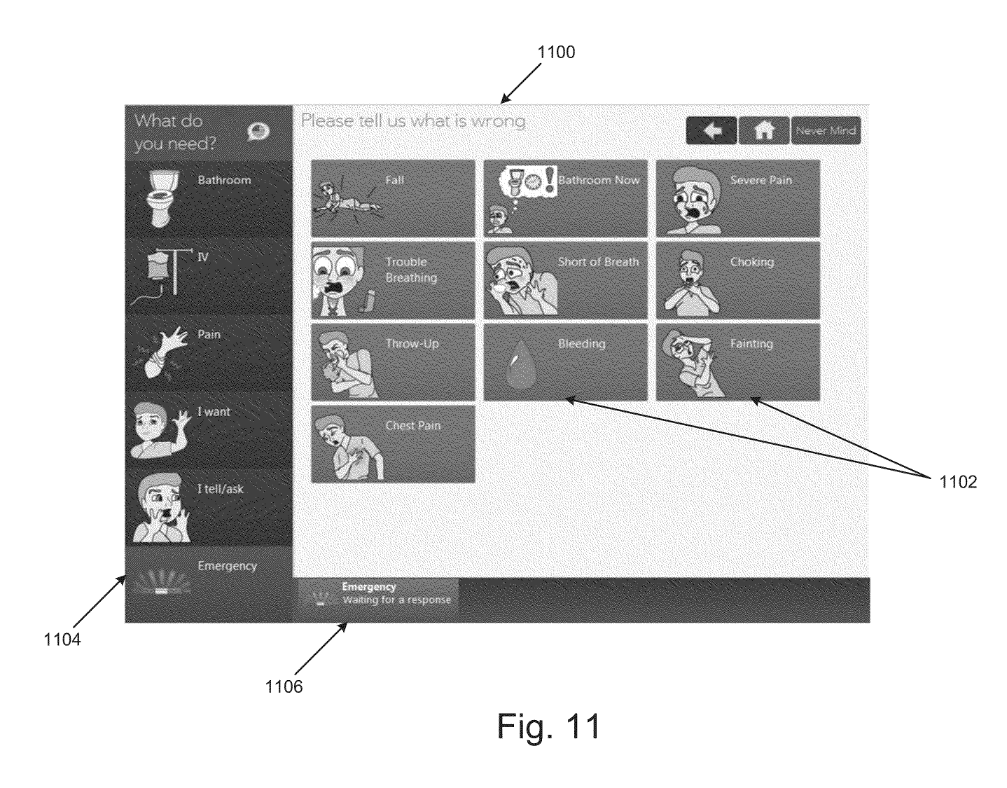

FIG. 11 illustrates an example of a user interface display 1100 for an emergency request using the visual call apparatus, according to an example of the present disclosure. Referring to FIGS. 1 and 11, using the emergencies module 120, the user interface display 1100 may present a variety of options and sub-options to the user 104. For example, for a health care environment, emergencies sub-options 1102 that are specific to the user 104 and the available emergencies option 1104 that can be provided by the service provider 108 may be determined by the analytics module 124 based on monitoring and analysis of data related to interactions with the apparatus 100. For the example shown in FIG. 11, the emergencies option 1104 may be related to an emergency the user is experiencing, and the emergencies sub-options 1102 may be related to pain, trouble breathing, etc. The user interface display 1100 may also include a status window 1106 related to the emergencies option 1104, or the emergencies sub-option 1102 that is selected.

Referring to FIGS. 1-11, the various displays for the user interface 106 may be used, for example, for user self-assessment and feedback. For example, for user self-assessment, a user may record conditions (e.g., medical or other conditions), either spontaneously or when prompted on a predetermined schedule. User feedback may be used to rate service providers (e.g., from 0-5 stars) or to give confidential feedback when there is a problem (e.g., “I am annoyed by NN”). Allowing the user to communication in a private and confidential environment may encourage such feedback, which may otherwise not be given.

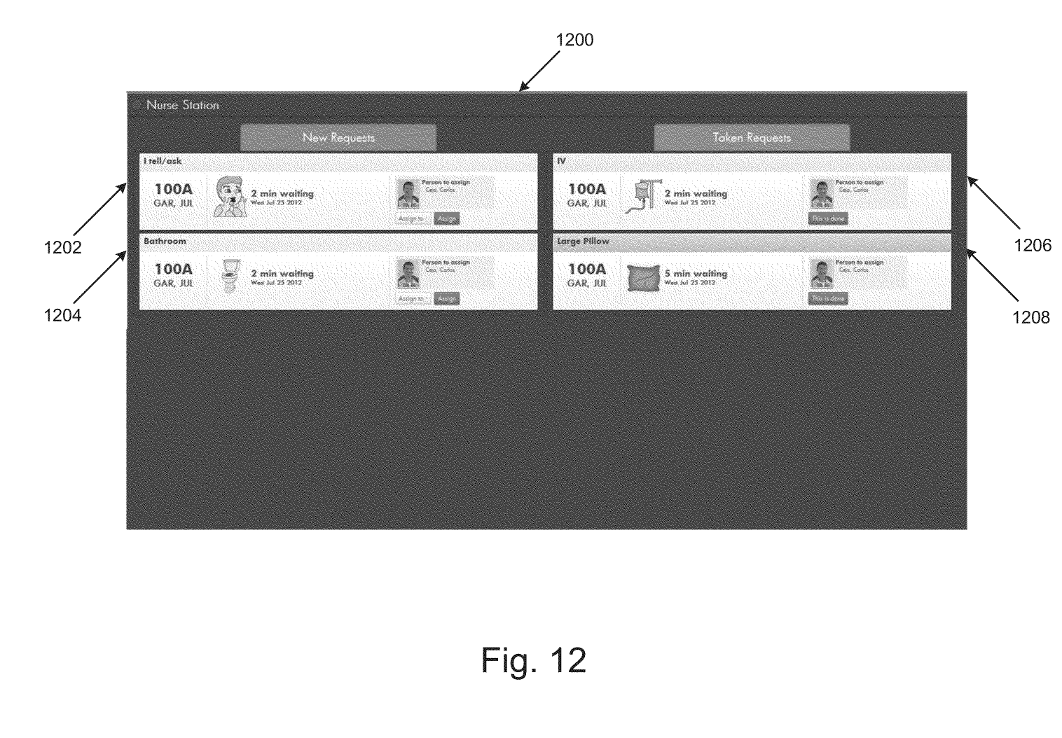

FIG. 12 illustrates an example of a service provider interface display 1200 using the visual call apparatus 100, according to an example of the present disclosure. Referring to FIGS. 1 and 12, the service provider interface display 1200 may generally include new requests that are submitted from the user 104 to the service provider 108, for example, at 1202, and 1204. Each new request may include the option and sub-option associated with the request, the time of the request, the status of the request, the user 104 making the request, and the appropriate service provider 108 who is assigned to the request, based, for example, on the service provider's qualifications and availability. Once a new request is processed, the processed requests may be displayed at 1206, 1208. Each processed request may include, for example, the option and sub-option associated with the request, the time of completion of the request, the status of the request, the user 104 making the request, and the service provider 108 who has completed the request. The time of the request and the time of completion of the request may be time-stamped for analysis by the analytics module 124.

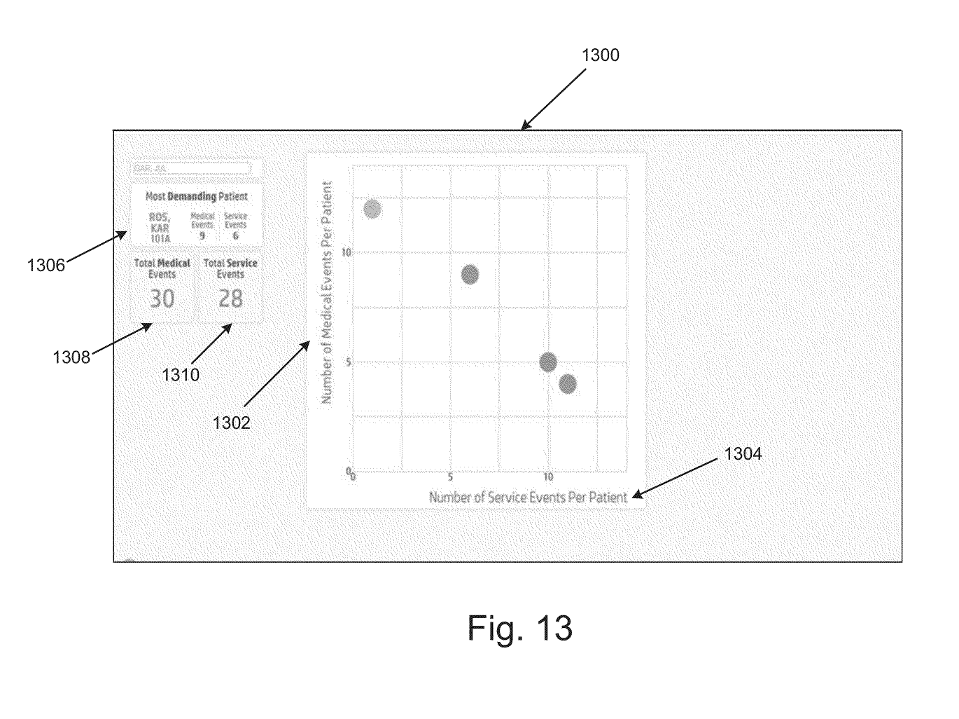

FIG. 13 illustrates a graph 1300 for a health care environment for evaluation of medical events per patient and service events per patient using the visual call apparatus 100, according to an example of the present disclosure. As discussed herein, factors such as the option and sub-options associated with a request, the time of the request and the time of completion of the request, the status of the request, the user 104 making the request, and the service provider 108 who is assigned to and completes the request may be recorded. These factors may be used by the analytics module 124 to determine, for example, user (e.g., patient) needs, workloads, response times, service provider assignment and task match or mismatch, and forecasting and staffing recommendations. The graph 1300 which illustrates evaluation of medical events per patient at 1302 and service events per patient at 1304 may be used to determine, for example, which patients are most demanding at 1306, based on total medical and service events at 1308, 1310. The medical events may include, for example, events related to a medical service (e.g., medication, change of bandages) provided to the patient, whereas the service events may include, for example, events related to general services (e.g., drink, bath) provided to the patient. For patients with high demands, the foregoing factors may be used by the analytics module 124 to determine, for example, needs of users with similar medical conditions, workloads for meeting the user's needs, response times that should be expected of service providers, service providers that should be assigned for certain users, service providers that should be assigned certain tasks, and staffing recommendations for similar users.

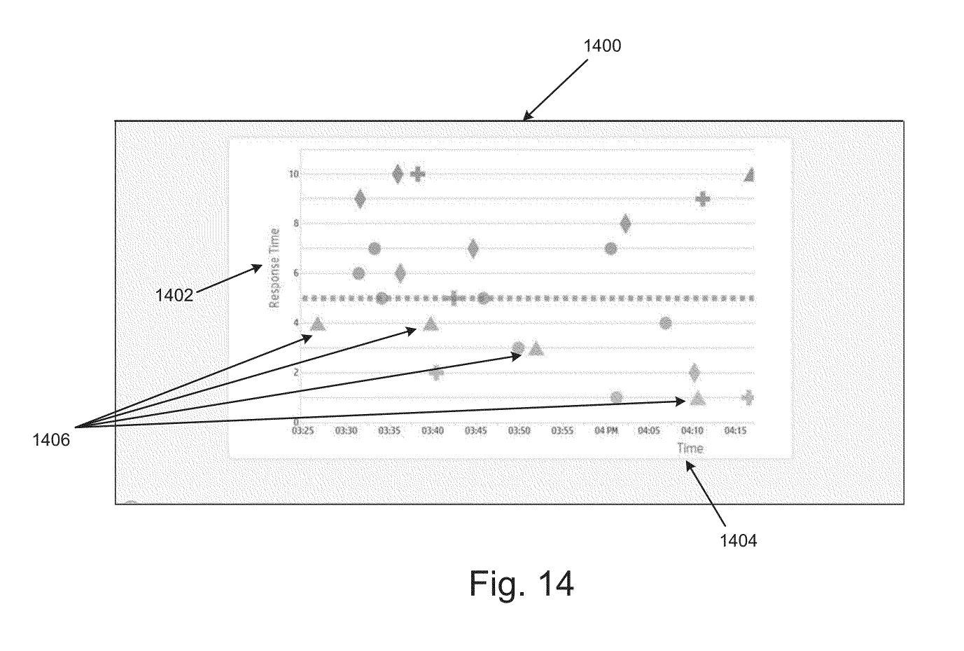

FIG. 14 illustrates a graph 1400 for evaluation of response time using the visual call apparatus 100, according to an example of the present disclosure. As discussed herein, factors such as the option and sub-options associated with a request, the time of the request and the time of completion of the request, the user 104 making the request, and the service provider 108 who is assigned to and completes the request may be recorded. These factors may be used by the analytics module 124 to determine, for example, user (e.g., patient) needs, workloads, response times, service provider assignment and task match or mismatch, and forecasting and staffing recommendations. The graph 1400 illustrates response time at 1402, a time window at 1404 (e.g., from 3:25 to 4:15), and associated plots for various tasks, for example at 1406 (represented by a triangle). Based on the evaluation of response time by the analytics module 124, metrics such as needs of users with similar medical conditions, workloads for meeting the user's needs, response times that should be expected of service providers (e.g., by comparison to predetermined thresholds for services), service providers that should be assigned for certain users, service providers that should be assigned certain tasks, staffing recommendations for similar users, and quality based aspects may be evaluated. The analytics module 124 may also use the foregoing and other factors to determine, for example, options and sub-options that are available a user, thus minimizing the possibility of user distress for services that are not provided in a reasonable time period.

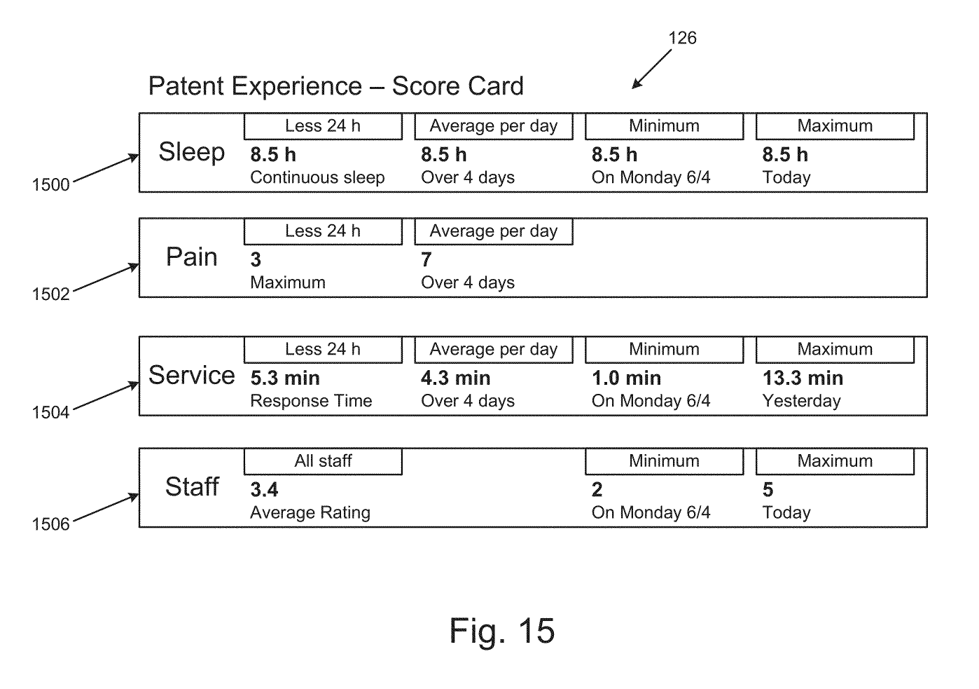

FIG. 15 illustrates a report 126 generated using the visual call apparatus 100, according to an example of the present disclosure. Referring to FIGS. 1 and 13-15, the report 126 may be generated by the analytics module 124 based, for example, on evaluation of the various metrics related to the interaction of the user 104 and the service provider 108 with the apparatus 100. For a health care environment, the report 126 may include, for example, information related to a user's sleep patter at 1500, information related to rating and scaling option 804 at 1502, information related to service option 304 at 1504, and staffing information at 1506. The information related to the user's sleep pattern at 1500, rating and scaling option 804 at 1502, service option 304 at 1504, and staffing information at 1506 may be used to determine, for example, workloads for meeting the user's needs, response times that should be expected of service providers, service providers that should be assigned for certain users, service providers that should be assigned certain tasks, staffing recommendations for similar users, and quality based aspects. Other information provided on the report 126 may include, for example, user feedback for service providers, and user feedback for services. The report 126 may thus be used for analysis and conclusions related to the user 104 and the service providers 108, and evaluated to assess a quality of service provided to the user 104. The analytics module 124 may also provide the report 126 to provide scores based on analysis of the metrics related to the user 104 and service provider 108. For example, for the information related to service option 304 at 1504, the timings related with such information may be converted to scores (e.g., 0-10) based on a comparison of actual versus expected timings for a service provider to thus facilitate rating of the service provider.

Referring to FIG. 1, the analytics module 124 may use signals received from the sensor 128 to determine, for example, a condition of the user 104. The sensor 128 may include an accelerometer 130 to sense vibrations in the vicinity of the user 104 and to thus provide a tap interface to determine a status of the user 104. For example, in a health care environment, the sensor 128 may be used to determine a status of the user 104 based on a number of consecutive taps detected. For example, in an emergency situation (e.g., the user has fallen), the user 104 may tap on the ground a predetermined number of times (e.g., 5 times) to alert the visual call apparatus 100, and thus the service provider 108. The user interface 106 may be used by the analytics module 124 to prompt the user for a response, and if no response is received within a predetermined time period, to automatically alert the service provider 108.

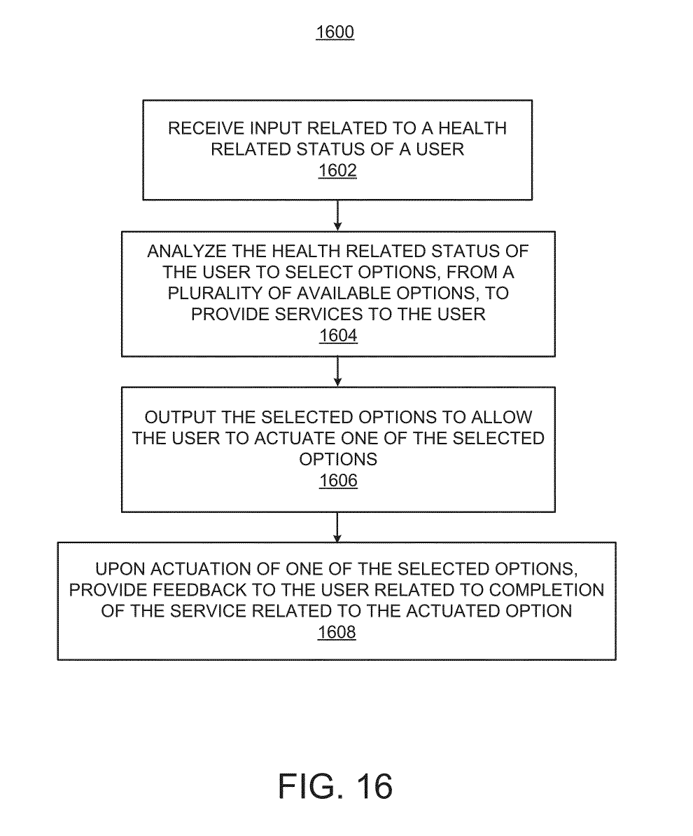

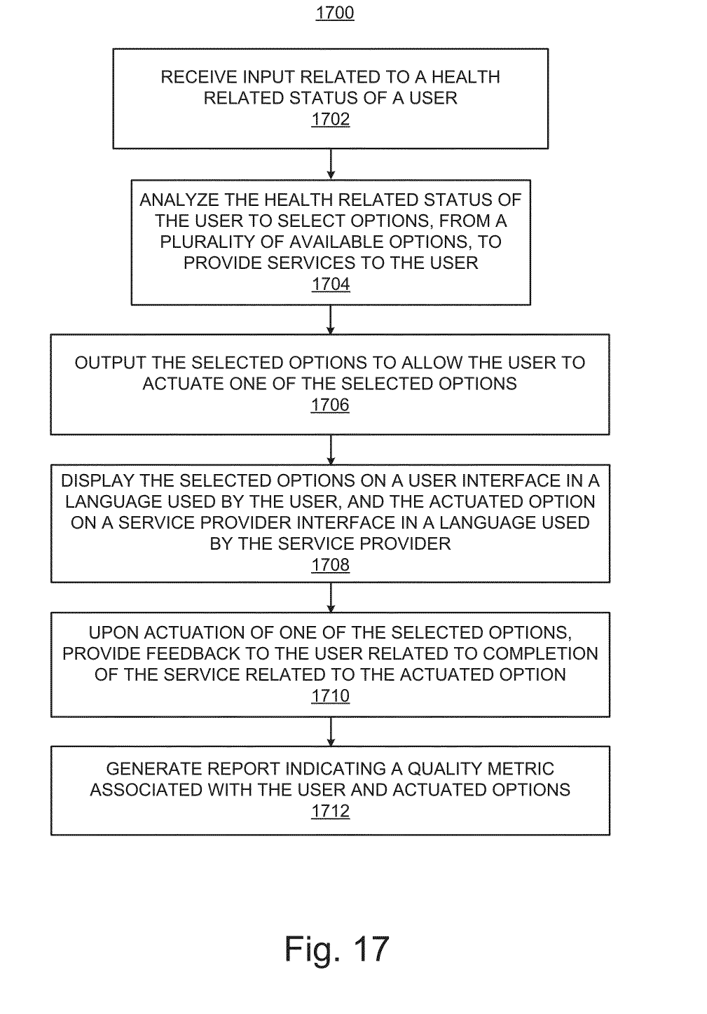

FIGS. 16 and 17 illustrate flowcharts of methods 1600 and 1700 for visual calling, corresponding to an example of the visual call apparatus 100 whose construction is described in detail above. The methods 1600 and 1700 may be implemented on the visual call apparatus 100 with reference to FIG. 1 by way of example and not limitation. The methods 1600 and 1700 may be practiced in other apparatus.

Referring to FIG. 16, for the method 1600, at block 1602, input related to a health related status of a user is received. For example, referring to FIG. 1, the analytics module 124 is to receive input related to a health related status (e.g., whether the user 104 is in ICU) of a user 104.

At block 1604, the health related status of the user is analyzed to select options, from a plurality of available options, to provide services to the user. The user is to actuate one of the selected options to receive a service related to the actuated option. For example, referring to FIGS. 1, 3 and 6-11, the analytics module 124 is to analyze the health related status of the user to select options (e.g., service option 304, bathroom option 602, problem report option 704, rating and scaling option 804, communication option 904, questions option 1004, and emergencies option 1104) from a plurality of available options (e.g., other options related to available services), to provide services to the user 104. The user 104 may actuate one of the selected options using the user interface 106 to receive a service related to the actuated option.

At block 1606, the selected options are output to allow the user to actuate one of the selected options. For example, referring to FIG. 1, the selected options are output at the user interface 106 to allow the user 104 to actuate one of the selected options.

At block 1608, upon actuation of one of the selected options, feedback related to completion of the service related to the actuated option is provided to the user. For example, referring to FIGS. 1, 3, and 4, for a service sub-option 302 selected by the user 104, for example, for requesting a large pillow, the user interface display 400 may provide feedback to the user 104 in the status window 402. Additional feedback may be provided to the user 104 in a similar manner for other options that are selected.

Referring to FIG. 17, for the method 1700, at block 1702, input related to a health related status of a user is received.

At block 1704, the health related status of the user is analyzed to select options, from a plurality of available options, to provide services to the user. The user is to actuate one of the selected options to receive a service related to the actuated option. Analyzing the health related status of the user may include analyzing previous urgent and non-urgent options (e.g., medical, or service options as shown in FIG. 13) actuated by the user, analyzing availability of service providers to complete the selected options, and/or analyzing a skill level of available service providers to complete the selected options.

At block 1706, the selected options are output to allow the user to actuate one of the selected options. For example, the selected options are displayed on a user interface in order of frequency of actuation of the selected options. Referring to FIGS. 1, 3 and 6-11, the selected options (e.g., service option 304, bathroom option 602, problem report option 704, rating and scaling option 804, communication option 904, questions option 1004, and emergencies option 1104) are displayed on the user interface 106 in order of frequency of actuation of the selected options.

At block 1708, the selected options are displayed on a user interface in a language used by the user, and the actuated option is displayed on a service provider interface in a language used by the service provider. For example, referring to FIG. 5, the selected options are displayed on the multi-lingual display 500 in a language used by the user. Similarly, referring to FIG. 12, the actuated option (e.g., at 1202, 1204) may be displayed on the service provider interface display 1200 in a language used by the service provider. As shown, for example, in FIG. 3, the selected options may include one or more related sub-options based on the analysis of the health related status of the user.

At block 1710, upon actuation of one of the selected options, feedback related to completion of a service related to the actuated option is provided to the user. The feedback may include an expected completion time for the service related to the actuated option.

At block 1712, a report is generated indicating a quality metric associated with the user and actuated options. For example, referring to FIG. 15, the report 126 may be generated by the analytics module 124 based, for example, on evaluation of the various metrics related to the interaction of the user 104 and the service provider 108 with the apparatus 100. The quality metric may be based, for example, on response time associated with completion of the actuated options.

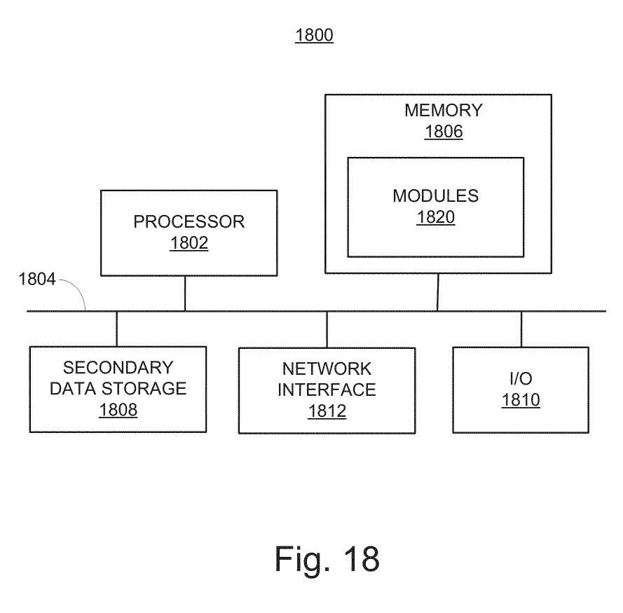

FIG. 18 shows a computer system 1800 that may be used with the examples described herein. The computer system represents a generic platform that includes components that may be in a server or another computer system. The computer system may be used as a platform for the apparatus 100. The computer system may execute, by a processor or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system includes a processor 1802 that may implement or execute machine readable instructions performing some or all of the methods, functions and other processes described herein. Commands and data from the processor 1802 are communicated over a communication bus 1804. The computer system also includes a main memory 1806, such as a random access memory (RAM), where the machine readable instructions and data for the processor 1802 may reside during runtime, and a secondary data storage 1808, which may be non-volatile and stores machine readable instructions and data. The memory and data storage are examples of computer readable mediums. The memory 1806 may include modules 1820 including machine readable instructions residing in the memory 1806 during runtime and executed by the processor 1802. The modules 1820 may include the modules 102, 112, 114, 116, 118, 120, 122, and 124 of the apparatus shown in FIG. 1.

The computer system may include an I/O device 1810, such as a keyboard, a mouse, a display, etc. The computer system may include a network interface 1812 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A visual call apparatus to provide a health care service to a user, the visual call apparatus comprising:
a memory storing machine readable instructions to:
receive input related to a health related status of a user;
analyze the health related status of the user to select options, from a plurality of available options, to provide services to the user, wherein the user is to actuate one of the selected options to receive a service related to the actuated option;
output the selected options to allow the user to actuate one of the selected options; and
upon actuation of one of the selected options, provide feedback to the user related to completion of the service related to the actuated option; and
a processor to implement the machine readable instructions.

2. The apparatus of claim 1, wherein outputting the selected options further comprises machine readable instructions to:
display the selected options on a user interface in order of frequency of actuation of the selected options.

3. The apparatus of claim 1, further comprising machine readable instructions to:
display the selected options on a user interface in a language used by the user; and
display the actuated option on a service provider interface in a language used by the service provider.

4. The apparatus of claim 1, wherein the feedback includes an expected completion time for the service related to the actuated option.

5. The apparatus of claim 1, wherein the selected options include at least one related sub-option based on the analysis of the health related status of the user.

6. The apparatus of claim 1, wherein analyzing the health related status of the user to select options further comprises machine readable instructions to:
analyze previous urgent and non-urgent options actuated by the user.

7. The apparatus of claim 1, wherein analyzing the health related status of the user to select options further comprises machine readable instructions to:
analyze availability of service providers to complete the selected options.

8. The apparatus of claim 1, wherein analyzing the health related status of the user to select options further comprises machine readable instructions to:
analyze a skill level of available service providers to complete the selected options.

9. The apparatus of claim 1, further comprising machine readable instructions to:
generate a report indicating a quality metric associated with the user and actuated options.

10. The apparatus of claim 9, wherein the quality metric is based on response time associated with completion of the actuated options.

11. The apparatus of claim 1, wherein determining the health related status of the user further comprises machine readable instructions to:
determine a number of consecutive vibrations in a vicinity of the user.

12. The apparatus of claim 1, further comprising machine readable instructions to:
prompt the user for a response based upon a determination of a predetermined number of consecutive vibrations in a vicinity of the user.

13. The apparatus of claim 1, further comprising machine readable instructions to:
record an interaction related to the actuated option between the user and a service provider.

14. A method for visual calling to provide a health care service to a user, the method comprising:
receiving input related to a health related status of a user;
analyzing, by a processor, the health related status of the user to select options, from a plurality of available options, by analyzing previous urgent and non-urgent options actuated by the user, wherein the user is to actuate one of the selected options to receive a service related to the actuated option;
outputting the selected options to allow the user to actuate one of the selected options; and
upon actuation of one of the selected options, providing feedback to the user related to completion of the service related to the actuated option.

15. A non-transitory computer readable medium having stored thereon machine readable instructions for visual calling for providing a health care service to a user, the machine readable instructions when executed cause a computer system to:
receive input related to a health related status of a user;
analyze, by a processor, the health related status of the user to select options, from a plurality of available options, by analyzing availability of service providers to complete the selected options, wherein the user is to actuate one of the selected options to receive a service related to the actuated option;
output the selected options to allow the user to actuate one of the selected options; and
upon actuation of one of the selected options, provide feedback to the user related to completion of the service related to the actuated option.
